(19) United States
(12) Patent Application Publication
(10) Pub. No.: US 2023/0297844 A1
(43) Pub. Date: Sep. 21, 2023

(54) FEDERATED LEARNING USING HETEROGENEOUS LABELS

(71) Applicant: Telefonaktiebolaget LM Ericsson (publ), Stockholm (SE)

(72) Inventors: Perepu SATHEESH KUMAR, Chennai (IN); Gautham Krishna GUDUR, Chennai (IN)

(73) Assignee: Telefonaktiebolaget LM Ericsson (publ), Stockholm (SE)

(21) Appl. No.: 18/016,636

(22) PCT Filed: Jul. 17, 2020
(86) PCT No.: PCT/IN2020/050618

§ 371 Date: Jan. 17, 2023

(51) Int. Cl. G06N 3/098; G06N 3/048

(52) U.S. Cl. CPC G06N 3/098; G06N 3/048

(57) ABSTRACT

A method for distributed learning at a local computing device is provided. The method includes: training a local model of a first model type on local data, wherein the local data comprises a first set of labels; testing the local model on a portion of global data pertaining to the first set of labels, wherein the global data comprises a second set of labels and the first set of labels is a strict subset of the second set of labels; as a result of testing the local model on the portion of the global data pertaining to the first set of labels, producing a first set of probabilities corresponding to the first set of labels; and sending the first set of probabilities corresponding to the first set of labels to a central computing device.

### TECHNICAL FIELD

Disclosed are embodiments related to federated learning using heterogeneous labels.

### BACKGROUND

In the past few years, machine learning has led to major breakthroughs in various areas, such as natural language processing, computer vision, speech recognition, and Internet of Things (IoT), with some breakthroughs related to automation and digitalization tasks. Most of this success stems from collecting and processing big data in suitable environments. For some applications of machine learning, this process of collecting data can be incredibly privacy invasive. One potential use case is to improve the results of speech recognition and language translation, while another one is to predict the next word typed on a mobile phone to increase the speed and productivity of the person typing. In both cases, it would be beneficial to directly train on the same data instead of using data from other sources. This would allow for training a model on the same data distribution (i.i.d.—independent and identically distributed) that is also used for making predictions. However, directly collecting such data might not always be feasible owing to privacy concerns. Users may not prefer nor have any interest in sending everything they type to a remote server/cloud.

One recent solution to address this is the introduction of federated learning, a new distributed machine learning approach where the training data does not leave the users' computing device at all. Instead of sharing their data directly, the client computing devices themselves compute weight updates using their locally available data. It is a way of training a model without directly inspecting clients' or users' data on a server node or computing device. Federated learning is a collaborative form of machine learning where the training process is distributed among many users. A server node or computing device has the role of coordinating between models, but most of the work is not performed by a central entity anymore but by a federation of users or clients.

After the model is initialized in every user or client computing device, a certain number of devices are randomly selected to improve the model. Each sampled user or client computing device receives the current model from the server node or computing device and uses its locally available data to compute a model update. All these updates are sent back to the server node or computing device where they are averaged, weighted by the number of training examples that the clients used. The server node or computing device then applies this update to the model, typically by using some form of gradient descent.

Current machine learning approaches require the availability of large datasets, which are usually created by collecting huge amounts of data from users or clients. Federated learning is a more flexible technique that allows training a model without directly seeing the data. Although the learning process is used in a distributed way, federated learning is quite different to the way conventional machine learning is used in data centers. The local data used in federated learning may not have the same guarantees about data distributions as in traditional machine learning processes, and communication is oftentimes slow and unstable between the local users or client computing devices and the server node or computing device. To be able to perform federated learning efficiently, proper optimization processes need to be adapted within each user machine or computing device. For instance, different telecommunications operators will each generate huge alarm datasets and relevant features. In this situation, there may be a good list of false alarms compared to the list of true alarms. For such a machine learning classification task, typically, the dataset of all operators in a central hub/repository would be required beforehand. This is required since different operators will encompass a variety of features, and the resultant model will learn their characteristics. However, this scenario is extremely impractical in real-time since it requires multiple regulatory and geographical permissions; and, moreover, it is extremely privacy-invasive for the operators. The operators often will not want to share their customers' data out of their premises. Hence, federated learning may provide a suitable alternative that can be leveraged to greater benefit in such circumstances.

### SUMMARY

The concept of federated learning is to build machine learning models based on data sets that are distributed across multiple computing devices while preventing data leakage. Recent challenges and improvements have been focusing on overcoming the statistical challenges in federated learning. There are also research efforts to make federated learning more personalizable. The above works all focus on on-device federated learning where distributed mobile user interactions are involved and communication cost in massive distribution, imbalanced data distribution, and device reliability are some of the major factors for optimization.

However, there is a shortcoming with the current federated learning approaches proposed. It is usually inherently assumed that clients or users try to train/update the same model architecture. In this case, clients or users do not have the freedom to choose their own architectures and modeling techniques. This can be a problem with clients or users since it can result in either overfitting or under fitting the local models on the computing devices. This might also result in an incompetent global model after model updating. Hence, it can be preferable for clients or users to select their own architecture/model tailored to their convenience, and the central resource can be used to combine these (potentially different) models in an effective manner.

Another shortcoming with the current approaches is that a real-time client or user might not have samples following an i.i.d. distribution. For instance, in an iteration client or user A can have 100 positive samples and 50 negative samples, while user B can have 50 positive sample, 30 neutral samples and 0 negative samples. In this case, the models in a federated learning setting with these samples can result in a poor global model.

Further, current federated learning approaches can only handle the situation where each of the local models have the same labels across all the clients or users and do not provide the flexibility to handle unique labels, or labels that may only be applicable to a subset of the clients or users. However, in many practical applications, having unique labels, or labels that may only be applicable to a subset of the clients or users, for each local model can be an important and common scenario owing to their dependencies and constraints on specific regions, demographics, etc. In this case, there may be different labels across all the data points specific to the region.

Embodiments proposed herein provide a method which can handle heterogeneous labels and heterogeneous models in a federated learning setting. It is believed that this method is first of its kind.

While embodiments handle heterogeneous labels and heterogeneous models for all the clients or users, it is generally assumed that the clients or users will have models directed at the same problem. That is, each client or user may have different labels or even different models, but each of the models will typically be directed to a common problem, such as image classification, text classification, and so on.

To handle the heterogeneous labels and heterogeneous models in a federated learning setting, embodiments provide a public dataset available to all the local clients or users and a global model server or user. Instead of sending the local model updates to the global server or user, the local clients or users may send the softmax probabilities obtained from applying their local models to the public dataset. The global server or user may then aggregate the softmax probabilities and distill the resulting model to a new student model on the obtained probabilities.

The global server or user now sends the probabilities from the distilled model to the local clients or users. Since the local models are already assumed to have at least a subset of the global model's labels, the distillation process is also run for the local client or user to create a local distilled student model, thus making the architectures of all the local models the same.

In this way, for example, the local model with a lesser number of labels is distilled to the model with a higher number of labels, while the global model with a higher number of labels is distilled to a model with a lesser number of labels. An added advantage of embodiments is that users can fit their own models (heterogeneous models) in the federated learning approach.

Embodiments can also advantageously handle different data distributions in the users, which typical federated learning systems cannot handle well.

According to a first aspect, a method for distributed learning at a local computing device is provided. The method includes training a local model of a first model type on local data, wherein the local data comprises a first set of labels. The method further includes testing the local model on a portion of global data pertaining to the first set of labels, wherein the global data comprises a second set of labels and the first set of labels is a strict subset of the second set of labels. The method further includes, as a result of testing the local model on the portion of the global data pertaining to the first set of labels, producing a first set of probabilities corresponding to the first set of labels. The method further includes sending the first set of probabilities corresponding to the first set of labels to a central computing device.

In some embodiments, the method further includes receiving a second set of probabilities from the central computing device; and updating the local model based on the second set of probabilities. In some embodiments, the method further includes, after training the local model of a first model type on local data, distilling the local model to create a distilled local model of a second model type, wherein testing the local model on a portion of the global data pertaining to the first set of labels comprises testing the distilled local model of the second model type. In some embodiments, updating the local model based on the second set of probabilities comprises a weighted average of the local model with a version of the local model from a previous iteration.

In some embodiments, the first set of probabilities correspond to softmax probabilities computed by the local model. In some embodiments, the local model is a classifier-type model. In some embodiments, the local data corresponds to an alarm dataset for a telecommunications operator, and the local model is a classifier-type model that classifies alarms as either a true alarm or a false alarm.

According to a second aspect, a method for distributed learning at a central computing device is provided. The method includes providing a central model of a first model type. The method further includes receiving a first set of probabilities corresponding to a first set of labels from a first local computing device. The method further includes receiving a second set of probabilities corresponding to a second set of labels from a second local computing device, wherein the second set of labels is different than the first set of labels. The method further includes updating the central model by combining the first and second sets of probabilities based on the first and second sets of labels. The method further includes sending model parameters for the updated central model to one or more of the first and second local computing devices.

In some embodiments, the method further includes distilling the updated central model to create a distilled central model of a second model type, and wherein the model parameters for the updated central model correspond to the distilled central model of the second model type. In some embodiments, updating the central model by combining the first and second sets of probabilities based on the first and second sets of labels comprises averaging probabilities of the first and second sets of probabilities corresponding to labels belonging to both the first and second sets of labels. In some embodiments, updating the central model by combining the first and second sets of probabilities based on the first and second sets of labels further comprises normalizing the combined first and second sets of probabilities.

In some embodiments, sending model parameters for the updated central model to one or more of the first and second local computing devices comprises sending model parameters for the updated central model to both of the first and second local computing devices. In some embodiments, the method further includes sending to both of the first and second local computing devices information about a common model type, and wherein the first and second sets of probabilities are model parameters based on the common model type. In some embodiments, the central model is a classifier-type model. In some embodiments, the local model is a classifier-type model that classifies alarms from a telecommunications operator as either a true alarm or a false alarm.

According to a third aspect, a user computing device is provided. The user computing device includes a memory; and a processor coupled to the memory. The processor is configured to train a local model of a first model type on local data, wherein the local data comprises a first set of labels. The processor is further configured to test the local model on a portion of global data pertaining to the first set of labels, wherein the global data comprises a second set of labels and the first set of labels is a strict subset of the second set of labels. The processor is further configured to, as a result of testing the local model on the portion of the global data pertaining to the first set of labels, produce a first set of probabilities corresponding to the first set of labels. The processor is further configured to send the first set of probabilities corresponding to the first set of labels to a central computing device.

According to a fourth aspect, a central computing device or server is provided. The central computing device or server includes a memory; and a processor coupled to the memory. The processor is configured to provide a central model of a first model type. The processor is further configured to receive a first set of probabilities corresponding to a first set of labels from a first local computing device. The processor is further configured to receive a second set of probabilities corresponding to a second set of labels from a second local computing device, wherein the second set of labels is different than the first set of labels. The processor is further configured to update the central model by combining the first and second sets of probabilities based on the first and second sets of labels. The processor is further configured to send model parameters for the updated central model to one or more of the first and second local computing devices.

According to a fifth aspect, a computer program is provided comprising instructions which when executed by processing circuitry causes the processing circuitry to perform the method of any one of the embodiments of the first or second aspects.

According to a sixth aspect, a carrier is provided containing the computer program of the fifth aspect, wherein the carrier is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 illustrates a federated learning system according to an embodiment.

FIG. 2 illustrates distillation according to an embodiment.

FIG. 3 illustrates a federated learning system according to an embodiment.

FIG. 4 illustrates a message diagram according to an embodiment.

FIG. 5 is a flow chart according to an embodiment.

FIG. 6 is a flow chart according to an embodiment.

FIG. 7 is a block diagram of an apparatus according to an embodiment.

FIG. 8 is a block diagram of an apparatus according to an embodiment.

### DETAILED DESCRIPTION

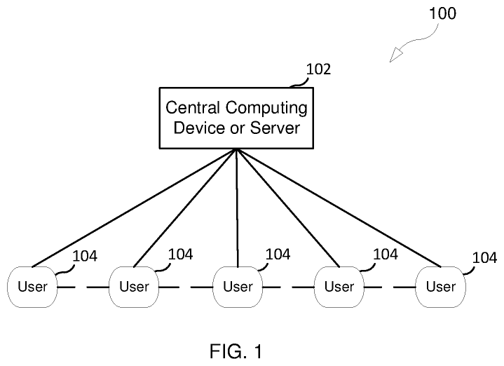

FIG. 1 illustrates a system 100 of federated learning according to an embodiment. As shown, a central computing device or server 102 is in communication with one or more users or client computing devices 104. Optionally, users 104 may be in communication with each other utilizing any of a variety of network topologies and/or network communication systems. For example, users 104 may include user devices such as a smart phone, tablet, laptop, personal computer, and so on, and may also be communicatively coupled through a common network such as the Internet (e.g., via WiFi) or a communications network (e.g., LTE or 5G). While a central computing device or server 102 is shown, the functionality of central computing device or server 102 may be distributed across multiple nodes, computing devices and/or servers, and may be shared between one or more of users 104.

Federated learning as described in embodiments herein may involve one or more rounds, where a global model is iteratively trained in each round. Users 104 may register with the central computing device or server to indicate their willingness to participate in the federated learning of the global model, and may do so continuously or on a rolling basis. Upon registration (and potentially at any time thereafter), the central computing device or server 102 may select a model type and/or model architecture for the local user to train. Alternatively, or in addition, the central computing device or server 102 may allow each user 104 to select a model type and/or model architecture for itself. The central computing device or server 102 may transmit an initial model to the users 104. For example, the central computing device or server 102 may transmit to the users a global model (e.g., newly initialized or partially trained through previous rounds of federated learning). The users 104 may train their individual models locally with their own data. The results of such local training may then be reported back to central computing device or server 102, which may pool the results and update the global model. This process may be repeated iteratively. Further, at each round of training the global model, central computing device or server 102 may select a subset of all registered users 104 (e.g., a random subset) to participate in the training round.

Embodiments provide a new architectural framework where the users 104 can choose their own architectural models while training their system. In general, an architecture framework establishes a common practice for creating, interpreting, analyzing, and using architecture descriptions within a domain of application or stakeholder community. In typical federated learning systems, each user 104 has the same model type and architecture, so combining the model inputs from each user 104 to form a global model is relatively simple. Allowing users 104 to have heterogeneous model types and architectures, however, presents an issue with how to address such heterogeneity by the central computing device or server 102 that maintains the global model. Embodiments also allow for local models to have differing sets of labels.

In some embodiments, each individual user 104 may have as a local model a particular type of neural network (NN) such as a Convolutional Neural Network (CNN). The specific model architecture for the NN is unconstrained, and different users 104 may have different model architectures. For example, NN architecture may refer to the arrangement of neurons into layers and the connection patterns between layers, activation functions, and learning methods. Referring specifically to CNNs, a model architecture may refer to the specific layers of the CNN, and the specific filters associated with each layer. In other words, in some embodiments different users 104 may each be training a local CNN type model, but the local CNN model may have different layers and/or filters between different users 104. Typical federated learning systems are not capable of handling this situation. Therefore, some modification of federated learning is needed. In particular, in some embodiments, the central computing device or server 102 generates a global model by intelligently combining the diverse local models. By employing this process, the central computing device or server 102 is able to employ federated learning over diverse model architectures.

Embodiments provide a way to handle heterogeneous labels among different users 104.

To demonstrate the general scenario of heterogeneous labels among users, let us assume the task of image classification across different animals with three users. User A in this example may have labels from two classes—‘Cat’ and ‘Dog’; User B may have labels from two classes—‘Dog’ and ‘Pig’; and User C may have labels from two classes—‘Cat’ and ‘Pig’. In all the users, the common theme is that they are working towards image classification and that the labels of the images are different for different users 104. This is a typical scenario with heterogeneous labels among users 104. While each user 104 in this example has the same number of labels, this is not a requirement; different users may have different numbers of labels. It may be the case that some users share substantially the same set of labels, having only a few labels that are different; it may also be the case that some users may have substantially different sets of labels than other users.

Generally speaking, many different types of problems relevant to many different industries will have local users 104 that have heterogeneous labels. For instance, let us assume that the users are telecommunications operators. Quite often, the operators have different data distributions and different labels with them. Some of the labels are common between these operators, while some labels tend to be more specialized and catered to certain operators only, or to operators within certain regions. Embodiments provide, in such situations, for a common and unified model in the federated learning framework since the operator typically will not transfer data due to privacy concerns and can gather only insights.

One challenge in addressing this problem is to combine these different local models (whether having different architectures altogether, or just different labels) into a single global model. This is not straightforward since the users can fit their own models, and they are usually built to describe only the local labels they have. Hence, there is a need for a method which can combine these local models to a global model.

A public dataset may be made available to all the local users and the global user. The public dataset contains data related to the union of all the labels across all the users. Suppose, for example, that the label set for User 1 is U₁, User 2 is U₂, . . . , and User P is U_{P}, the union of all the labels forms the global user label set {U₁∪U₂∪U₃ . . . ∪U_{P}}. The public dataset contains data corresponding to each of the labels in the global user label set. In embodiments, this dataset can be small, so that it may be readily shared with all the local users, as well as the global user.

The P local users (l₁, l₂, . . . , l_{P}) and a global user g form the federated learning environment. The local users (l₁, l₂, . . . , l_{P}) correspond to users 104 and the global user g corresponds to the central computing device or server 102, as illustrated in FIG. 1.

The local users 104 have their own local data, which may vary in each iteration. In the i^{th} iteration, the local data for local user lⱼ may be denoted by Dᵢⱼ, and the model built may be denoted by mᵢⱼ, where j=1, 2 . . . , P. In embodiments, each local user 104 can have the choice of building their own model architecture; e.g., one model can be a CNN, while other models can be Recurrent Neural Network (RNN) or a feed-forward NN and so on. In other embodiments, each user may have the same model architecture, but is given the choice to maintain its own set of labels for that architecture.

The local users 104 may test their local model mᵢⱼ on the public dataset, using only the rows of the data applicable for the labels being used by the specific local user lⱼ. Based on testing the local model on the public dataset, the local users may compute the softmax probabilities. In some embodiments, the local user 104 may first distill its local model to a common architecture, and test the distilled local model to compute the softmax probabilities. The softmax probabilities refers to the final layer of a classifier, which provides probabilities (summing to 1) for each of the classes (labels) that the model is trained on. This is typically implemented with a softmax function, but probabilities generated through other functions are also within the scope of the disclosed embodiments. Each row of the public dataset that is applicable for the labels being used by the specific local user lⱼ may generate a set of softmax probabilities, and the collection of these probabilities for each relevant row of the public dataset may be sent to the global user g for updating the global model.

Following this, the global user g receives the softmax probabilities from all the local users 104 and combines (e.g., averages) them separately for each label in the global user label set. The averaged softmax label probability distributions oftentimes will not sum to up to 1; in this case, normalization mechanisms may be used to ensure the sum of the probabilities for each label is 1.

The respective softmax probabilities of labels are then sent to the respective users. In embodiments, the global user g may first distill its model to a simpler model that is easier to share with local users 104. This may, in embodiments, involve preparing a model specific to a given local user 104. In order to do so, the subset of the rows of the public dataset having labels applicable to the given local user 104 may be fed as an input feature space along with the corresponding softmax probabilities, and a distilled model may be computed. This distilled model (created by the global user g) may be denoted by

$${l}_{{d}_{ij}} ,$$

where (as before) i refers to the i-th iteration and j refers to the local user lⱼ. In embodiments, all distilled models across all the local users 104 have the same common architecture, even where the individual local users 104 may have different architectures for their local models.

The local user 104 then receives the (distilled) model from the global user g. As noted earlier, the local user 104 may have distilled its local model m_{i+1,j} prior to transmitting the model probabilities to the global user g. Both of these models may be distilled to the same architecture type. At the end of an iteration, the local user 104 may in some embodiments update its model by weighting it with the model from a previous iteration. For example, at the i+1-th iteration, the model may be computed as

$${i}_{{d}_{i + 1 , j}} = {l}_{{d}_{ij}} + α {l}_{i + 1 , j} ,$$

where α value is a dynamic value chosen between 0 to 1 depending on the number of data points available in the current iteration. For the first iteration, the weighting may not be applied.

These steps may be repeated until the number of iterations are exhausted in the federated learning architecture.

In this way, embodiments can handle heterogeneous labels as well as heterogeneous models in federated learning. This is very useful in applications where users are participating from different organizations which may have multiple and disparate labels. The different labels may contain common standard labels available with all or many of the companies, and in addition, may have company specific labels available.

An added advantage of the proposed method is that it can handle different distributions of samples across all the users, which can be common in any application.

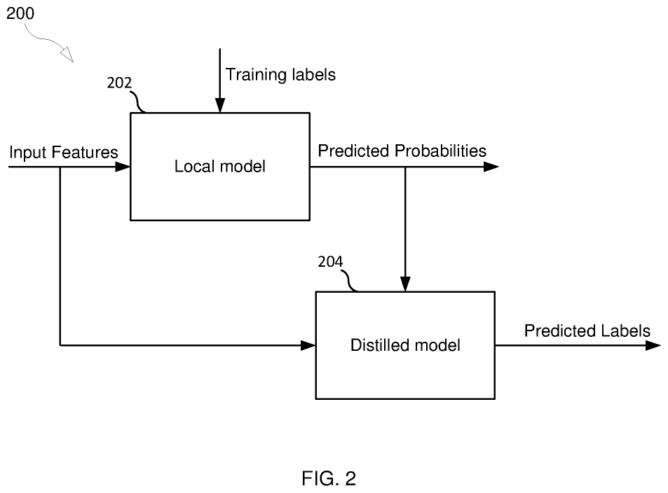

FIG. 2 illustrates distillation 200 according to an embodiment. There are two models involved in distillation 200, the local model 202 (also referred to as the “teacher” model) and the distilled model 204 (also referred to as the “student” model). Usually, the teacher model is complex and trained using a graphics processing unit (GPU), a central processing unit (CPU), or another device with similar processing resources, whereas the student model is trained on a device having less powerful computational resources. This is not essential, but because the “student” model is easier to train than the original “teacher” model, it is possible to use less processing resources to train it. In order to keep the knowledge of the “teacher” model, the “student” model is trained on the predicted probabilities of the “teacher” model. The local model 202 and the distilled model 204 may be of different model types and/or model architectures.

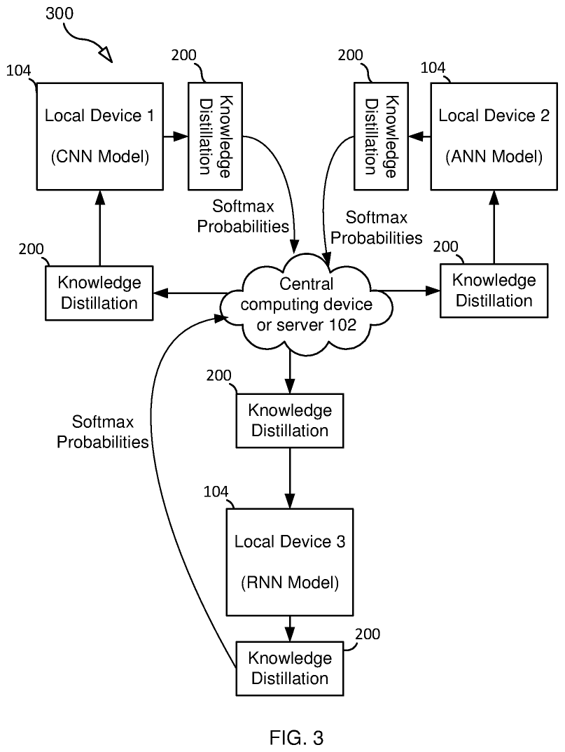

FIG. 3 illustrates a system 300 according to some embodiments. System 300 includes three users 104, labeled as “Local Device 1”, “Local Device 2”, and “Local Device 3”. These users may have heterogeneous labels. Continuing with the example image classification described above, local device 1 may have labels for ‘Cat’ and ‘Dog’; local device 2 may have labels for ‘Cat’ and ‘Pig’; and local device 3 may have labels for ‘Pig’ and ‘Dog.’ As illustrates, the users also have different model types (a CNN model, an Artificial Neural Network (ANN) model, and an RNN model, respectively). System 300 also includes a central computing device or server 102.

As described above, for a given iteration of federated learning, each of the users 104 will test their local trained model on the public dataset. This may first involve distilling the models using knowledge distillation 200. As a result of testing the trained models, the local users 104 send softmax probabilities to the central computing device or server 102. The central computing device or server 102 combines these softmax probabilities and updates its own global model. It can then send model updates to each of the local users 104, first passing the model to knowledge distillation 200, and tailoring the model updates to be specific to the local device 104 (e.g., specific to the labels used by the local device 104).

As shown, there are three different local devices which consist of different labels and architectures. Interaction happens between a central global model which exists in the central computing device or server 102, and the users 104 are local client computing devices e.g., configurations with embedded systems or mobile phones.

A simple knowledge distillation 200 task of distilling from a one model type (e.g., a heavy-computation architecture/model) to another (e.g., a light-weight model, such as a one- or two-layered feed-forward ANN) is capable of running on low-resource constrained device, such as one having ˜256 MB RANI. This makes the knowledge distillation 200 suitable for running on many types of local client computing devices, including contemporary mobile/embedded devices such as smartphones.

### Example

We collected a public dataset of all labels in the data and made it available to all the users herein the telecommunications operators. The public dataset consisted of an alarms dataset corresponding to three telecommunications operators. For the example, the first operator has three labels {l₁, l₂, l₃}, the second operator has three labels {l₂, l₃, l₄}, and the third operator has three labels {l₂, l₄, l₅}. The dataset has similar features, but has different patterns and different labels. The objective for each of the users is to classify the alarms as either a true alarm or a false alarm based on their respective features.

The users have the choice of building their own models. In this example, each of the users employ a CNN model, but unlike a normal federated learning setting, the users may select their own architecture (e.g., different number of layers and filters in each layers) for the CNN model. Based on the dataset, operator 1 chooses to fit a three-layer CNN with 32, 64 and 32 filters in each layer respectively. Similarly, operator 2 chooses to fit a two-layer ANN model with 32 and 64 filters in each layer respectively. Finally, the operator 3 chooses to fit a two-layered RNN with 32 and 50 units each. These models are chosen based on the nature of local data and different iterations.

In this case, the global model is constructed as follows. The softmax probabilities of the local model are computed on the subset of public data to which the labels in the local model have access to. The computed softmax probabilities of all the local users are sent back to the global user. The average of all distributions of all local softmax probabilities are computed and are send back to the local users. These steps repeat for multiple iterations of the federated learning model.

In the example, the common distilled architecture used here is a single-layer ANN model.

The final accuracies obtained for the three local models are 82%, 88% and 75%. After the global model is constructed, the final accuracies obtained at the three local models are 86%, 94% and 80%. In this way, we evaluate that the federated learning model with our proposed approach is effective and yields better results, when compared to the local models operating by themselves. The model is run for 50 iterations and we report these accuracies across three different experimental trials, and we average the accuracies.

While an example involving telecommunication operators classifying an alarm as a true or false alarm is provided, embodiments are not limited to this example. Other classification models and domains are also encompassed. For example, another scenario involves the IoT sector, where the labels of the data may be different in different geographical locations. A global model according to embodiments provided herein can handle different labels across different locations. As an example, assume that location 1 has only two labels (e.g., ‘hot’ and ‘moderately hot’), and location 2 has two labels (‘moderately hot’ and ‘cold’).

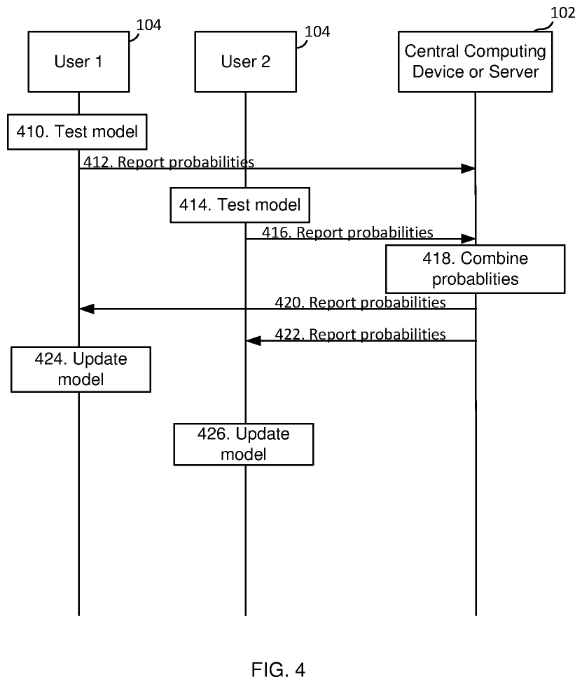

FIG. 4 illustrates a message diagram according to an embodiment. Local users or client computing devices 104 (two local users are shown) and central computing device or server 102 communicate with each other. The local users first test their local model at 410 and 414. The test occurs against a public dataset, and may be made by a distilled version of each of the local models, where the local users 104 distill their local models to a common architecture. After testing, the local users 104 send or report the probabilities from the test to the central computing device or server 102 at 412 and 416. These probabilities may be so-called “softmax probabilities,” which typically result from the final layer of a NN. For each row of data in the public dataset relevant to a given local user 104, the user will transmit a set of probabilities corresponding to each of the labels that the local user 104 trains its model on. The central computing device or server 102 collects the probabilities from each of the local users 104, and combines them at 418. This combination may be a simple average of the probabilities, or it may involve more processing. For example, probabilities from some local computing devices 104 may be weighted higher than others. The central computing device or server 102 may also normalize the combined probabilities, to ensure that they sum to 1. The combined probabilities are sent back to the local computing devices 104 at 420 and 422. These may be tailored specifically to each local computing device 104. For example, the central computing device or server 102 may distill the model to a common architecture, and may send only the probabilities related to labels that the local user 104 trains its model on. Once received, the local users 104 use the probabilities to update their local models at 424 and 426.

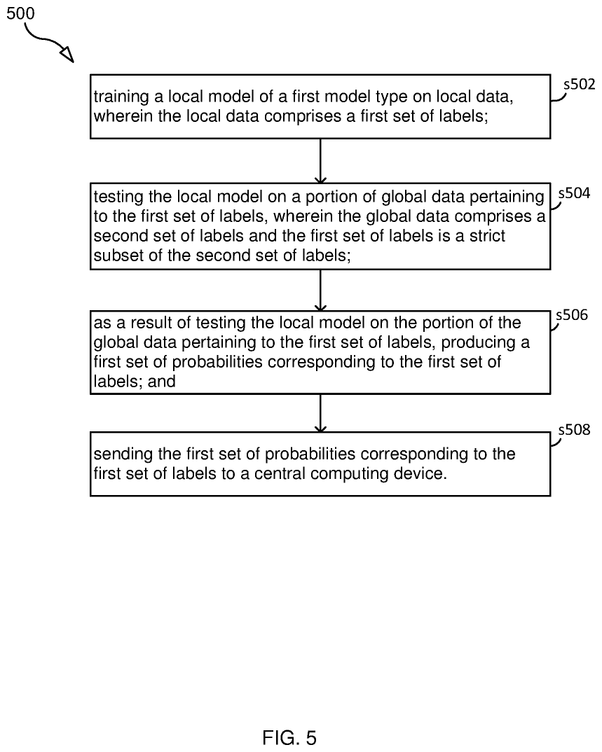

FIG. 5 illustrates a flow chart according to an embodiment. Process 500 is a method for distributed learning at a local computing device. Process 500 may begin with step s502.

Step s502 comprises training a local model of a first model type on local data, wherein the local data comprises a first set of labels.

Step s504 comprises testing the local model on a portion of global data pertaining to the first set of labels, wherein the global data comprises a second set of labels and the first set of labels is a strict subset of the second set of labels.

Step s506 comprises, as a result of testing the local model on the portion of the global data pertaining to the first set of labels, producing a first set of probabilities corresponding to the first set of labels.

Step s508 comprises sending the first set of probabilities corresponding to the first set of labels to a central computing device.

In some embodiments, the method further includes receiving a second set of probabilities from the central computing device; and updating the local model based on the second set of probabilities. In some embodiments, the method further includes, after training the local model of a first model type on local data, distilling the local model to create a distilled local model of a second model type, wherein testing the local model on a portion of the global data pertaining to the first set of labels comprises testing the distilled local model of the second model type.

In some embodiments, updating the local model based on the second set of probabilities comprises a weighted average of the local model with a version of the local model from a previous iteration. In some embodiments, the first set of probabilities correspond to softmax probabilities computed by the local model. In some embodiments, the local model is a classifier-type model. In some embodiments, the local data corresponds to an alarm dataset for a telecommunications operator, and the local model is a classifier-type model that classifies alarms as either a true alarm or a false alarm.

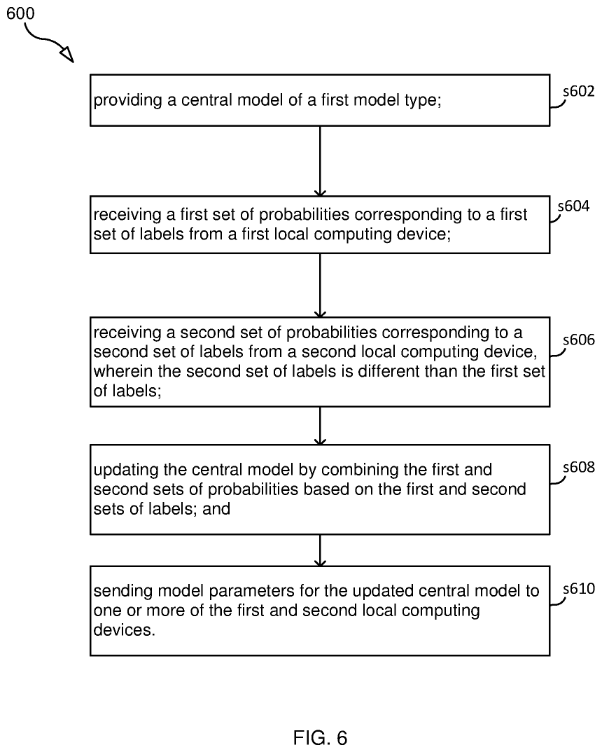

FIG. 6 illustrates a flow chart according to an embodiment. Process 600 is a method for distributed learning at a central computing device. Process 600 may begin with step s602.

Step s602 comprises providing a central model of a first model type.

Step s604 comprises receiving a first set of probabilities corresponding to a first set of labels from a first local computing device.

Step s606 comprises receiving a second set of probabilities corresponding to a second set of labels from a second local computing device, wherein the second set of labels is different than the first set of labels.

Step s608 comprises updating the central model by combining the first and second sets of probabilities based on the first and second sets of labels.

Step s610 comprises sending model parameters for the updated central model to one or more of the first and second local computing devices.

In some embodiments, the method further includes distilling the updated central model to create a distilled central model of a second model type, and wherein the model parameters for the updated central model correspond to the distilled central model of the second model type. In some embodiments, updating the central model by combining the first and second sets of probabilities based on the first and second sets of labels comprises averaging probabilities of the first and second sets of probabilities corresponding to labels belonging to both the first and second sets of labels. In some embodiments, updating the central model by combining the first and second sets of probabilities based on the first and second sets of labels further comprises normalizing the combined first and second sets of probabilities.

In some embodiments, sending model parameters for the updated central model to one or more of the first and second local computing devices comprises sending model parameters for the updated central model to both of the first and second local computing devices. In some embodiments, the method further includes sending to both of the first and second local computing devices information about a common model type, and wherein the first and second sets of probabilities are model parameters based on the common model type. In some embodiments, the central model is a classifier-type model. In some embodiments, the local model is a classifier-type model that classifies alarms from a telecommunications operator as either a true alarm or a false alarm.

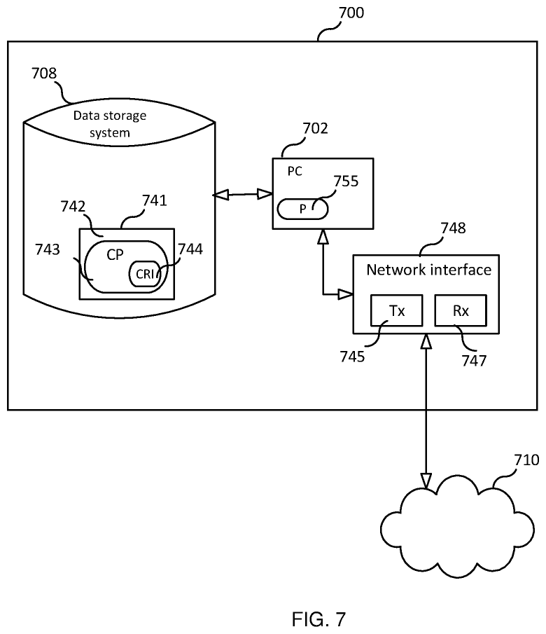

FIG. 7 is a block diagram of an apparatus 700 (e.g., a user 104 and/or central computing device or server 102), according to some embodiments. As shown in FIG. 7, the apparatus may comprise: processing circuitry (PC) 702, which may include one or more processors (P) 755 (e.g., a general purpose microprocessor and/or one or more other processors, such as an application specific integrated circuit (ASIC), field-programmable gate arrays (FPGAs), and the like); a network interface 748 comprising a transmitter (Tx) 745 and a receiver (Rx) 747 for enabling the apparatus to transmit data to and receive data from other computing devices connected to a network 710 (e.g., an Internet Protocol (IP) network) to which network interface 748 is connected; and a local storage unit (a.k.a., “data storage system”) 708, which may include one or more non-volatile storage devices and/or one or more volatile storage devices. In embodiments where PC 702 includes a programmable processor, a computer program product (CPP) 741 may be provided. CPP 741 includes a computer readable medium (CRM) 742 storing a computer program (CP) 743 comprising computer readable instructions (CRI) 744. CRM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes the apparatus to perform steps described herein (e.g., steps described herein with reference to the flow charts). In other embodiments, the apparatus may be configured to perform steps described herein without the need for code. That is, for example, PC 702 may consist merely of one or more ASICs. Hence, the features of the embodiments described herein may be implemented in hardware and/or software.

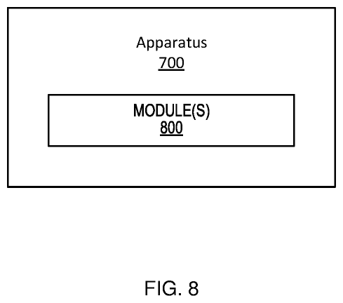

FIG. 8 is a schematic block diagram of the apparatus 700 according to some other embodiments. The apparatus 700 includes one or more modules 800, each of which is implemented in software. The module(s) 800 provide the functionality of apparatus 800 described herein (e.g., the steps herein, e.g., with respect to FIGS. 3-6).

While various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for distributed learning at a local computing device, the method comprising:
training a local model of a first model type on local data, wherein the local data comprises a first set of labels;
testing the local model on a portion of global data pertaining to the first set of labels, wherein the global data comprises a second set of labels and the first set of labels is a strict subset of the second set of labels;
as a result of testing the local model on the portion of the global data pertaining to the first set of labels, producing a first set of probabilities corresponding to the first set of labels; and
sending the first set of probabilities corresponding to the first set of labels to a central computing device.

2. The method of claim 1, further comprising
receiving a second set of probabilities from the central computing device; and
updating the local model based on the second set of probabilities.

3. The method of claim 1, further comprising:
after training the local model of a first model type on local data, distilling the local model to create a distilled local model of a second model type,
wherein testing the local model on a portion of the global data pertaining to the first set of labels comprises testing the distilled local model of the second model type.

4. The method of claim 2, wherein updating the local model based on the second set of probabilities comprises a weighted average of the local model with a version of the local model from a previous iteration.

5. The method of claim 1, wherein the first set of probabilities correspond to softmax probabilities computed by the local model.

6. The method of claim 1, wherein
the local model is a classifier-type model, and
the local data corresponds to an alarm dataset for a telecommunications operator.

7. (canceled)

8. A method for distributed learning at a central computing device, the method comprising:
providing a central model of a first model type;
receiving a first set of probabilities corresponding to a first set of labels from a first local computing device;
receiving a second set of probabilities corresponding to a second set of labels from a second local computing device, wherein the second set of labels is different than the first set of labels;
updating the central model by combining the first and second sets of probabilities based on the first and second sets of labels; and
sending model parameters for the updated central model to one or more of the first and second local computing devices.

9. The method of claim 8, further comprising distilling the updated central model to create a distilled central model of a second model type, and wherein the model parameters for the updated central model correspond to the distilled central model of the second model type.

10. The method of claim 8, wherein updating the central model by combining the first and second sets of probabilities based on the first and second sets of labels comprises averaging probabilities of the first and second sets of probabilities corresponding to labels belonging to both the first and second sets of labels.

11. The method of claim 8, wherein updating the central model by combining the first and second sets of probabilities based on the first and second sets of labels further comprises normalizing the combined first and second sets of probabilities.

12. The method of claim 8, wherein sending model parameters for the updated central model to one or more of the first and second local computing devices comprises sending model parameters for the updated central model to both of the first and second local computing devices.

13. The method of claim 8, further comprising sending to both of the first and second local computing devices information about a common model type, and wherein the first and second sets of probabilities are model parameters based on the common model type.

14. The method of claim 8, wherein the central model is a classifier-type model.

15. (canceled)

16. A user computing device comprising:
a memory;
a processor coupled to the memory, wherein the processor is configured to:
train a local model of a first model type on local data, wherein the local data comprises a first set of labels;
test the local model on a portion of global data pertaining to the first set of labels, wherein the global data comprises a second set of labels and the first set of labels is a strict subset of the second set of labels;
as a result of testing the local model on the portion of the global data pertaining to the first set of labels, produce a first set of probabilities corresponding to the first set of labels; and
send the first set of probabilities corresponding to the first set of labels to a central computing device.

17. The user computing device of claim 16, wherein the processor is further configured to:
receive a second set of probabilities from the central computing device; and
update the local model based on the second set of probabilities.

18. The user computing device of claim 16, wherein the processor is further configured to:
after training the local model of a first model type on local data, distill the local model to create a distilled local model of a second model type,
wherein testing the local model on a portion of the global data pertaining to the first set of labels comprises testing the distilled local model of the second model type.

19. The user computing device of claim 17, wherein updating the local model based on the second set of probabilities comprises a weighted average of the local model with a version of the local model from a previous iteration.

20. (canceled)

21. The user computing device of claim 16, wherein the local model is a classifier-type model.

22. (canceled)

23. A central computing device or server comprising:
a memory; and
a processor coupled to the memory, wherein the processor is configured to:
provide a central model of a first model type;
receive a first set of probabilities corresponding to a first set of labels from a first local computing device;
receive a second set of probabilities corresponding to a second set of labels from a second local computing device, wherein the second set of labels is different than the first set of labels;
update the central model by combining the first and second sets of probabilities based on the first and second sets of labels; and
send model parameters for the updated central model to one or more of the first and second local computing devices.

24-30. (canceled)

31. A non-transitory computer readable storage medium storing a computer program comprising instructions which when executed by processing circuitry causes the processing circuitry to perform the method of claim 1.

32. (canceled)
